(19) United States
(12) Patent Application Publication
(10) Pub. No.: US 2016/0216817 A1
(43) Pub. Date: Jul. 28, 2016

(54) ARRAY SUBSTRATE, METHOD FOR PRODUCING THE SAME AND DISPLAY APPARATUS

(71) Applicants: BOE Technology Group Co., Ltd., Beijing (CN); Beijing BOE Optoelectronics Technology Co., Ltd., Beijing (CN)

(72) Inventors: Shengji Yang, Beijing (CN); Xue Dong, Beijing (CN); Haisheng Wang, Beijing (CN); Hailin Xue, Beijing (CN); Weijie Zhao, Beijing (CN); Rui Xu, Beijing (CN); Zhiying Bao, Beijing (CN); Yue Li, Beijing (CN); Yanchen Li, Beijing (CN); Zhenhua Lv, Beijing (CN); Xi Chen, Beijing (CN)

(21) Appl. No.: 14/801,271

(22) Filed: Jul. 16, 2015

(30) Foreign Application Priority Data
Jan. 26, 2015 (CN) 201510038766.3

(51) Int. Cl. G06F 3/041

(52) U.S. Cl. CPC G06F 3/0412; G06F 2203/04103

(57) ABSTRACT

The present disclosure provides an array substrate, a method for producing the same and a display apparatus. The array substrate comprises: a substrate; a touch electrode wiring pattern formed on the substrate, the touch electrode wiring pattern comprising a plurality of touch electrode wirings; a common electrode pattern formed on the substrate, the common electrode pattern being insulated from the touch electrode wiring pattern and comprising a plurality of block electrodes spaced mutually, wherein the common electrode pattern is also used as a touch electrode pattern, and wherein each of the touch electrode wirings is connected correspondingly to one of the block electrodes in the common electrode pattern.

### CROSS-REFERENCE TO RELATED APPLICATION

This application claims the benefit of Chinese Patent Application No. 201510038766.3 filed on Jan. 26, 2015 in the State Intellectual Property Office of China, titled with “array substrate, method for producing the same and display apparatus”, the whole disclosure of which is incorporated herein by reference.

### BACKGROUND OF THE INVENTION

1. Field of the Invention

The present disclosure relates to a technical field of display, and in particular, relates to an array substrate, a method for producing the same and a display apparatus.

2. Description of the Related Art

As the display technology develops rapidly, a touch screen panel has been used widely in the people's lives. At present, in terms of configurations, the touch screen panel may be classified into an Add on Mode Touch Panel, an On Cell Touch Panel and an In Cell Touch Panel. In production of the Add on Mode Touch Panel, the touch screen panel and the liquid crystal display (LCD) are produced separately and then are adhered to each other to form a liquid crystal display having touch function. The Add on Mode Touch Panel has disadvantages of such as high production cost, low light transmittance and high thickness of module. In the In Cell Touch Panel, the touch electrode of the touch panel is embedded inside the liquid crystal display, which may not only reduce the thickness of the module in entirety, but also may reduce the production cost of the touch panel significantly. Thus, it is popular to major panel manufacturers.

Now, the conventional In Cell touch panel uses the principle of mutual capacitance or self capacitance to detect a finger touch position. In an example, on the basis of the principle to the self capacitance, a plurality of self capacitance electrodes arranged in the same layer and insulated mutually may be provided in the touch panel. When the human body does not touch the panel, the capacitances to which the capacitance electrodes are subject are kept as a constant value. When the human body touches the panel, the capacitance to which the corresponding self capacitance electrode is subject becomes the sum of the constant value and the capacitance of the human body; and a touch detection chip may determine the touch position by detecting variation of the capacitance values of the self capacitance electrodes in a touch period. In the self capacitance touch panel, the capacitance of the human body may be used as all of the self capacitances while the capacitance of the human body may only be used as a projection capacitance in the mutual capacitance, thus, the touch variation amount caused by touching panel by the human body may be greater than the touch panel produced on the basis of the principle of mutual capacitance. In this way, the self capacitance touch panel may improve the touch signal-noise-ratio efficiently, so as to improve the accuracy of touch induction, in comparison with the mutual capacitance touch panel.

In the prior art, typically, a layer of touch electrode pattern is formed separately on an array substrate or a color film substrate. The touch electrode pattern includes a plurality of separate touch electrodes as a pole plate of the self capacitance capacitor and forms touch electrode wiring detection touch signals connected to various touch electrode wirings. In this way, the thickness of the touch display apparatus in entirety may be increased.

### SUMMARY OF THE INVENTION

An object of embodiments of the present invention provide an array substrate, a method for producing the same and a display apparatus, which can reduce the thickness of the touch display apparatus.

In accordance with an aspect the present invention, it provides an array substrate comprising:

a substrate;

a touch electrode wiring pattern formed on the substrate, the touch electrode wiring pattern comprising a plurality of touch electrode wirings;

a common electrode pattern formed on the substrate, the common electrode pattern being insulated from the touch electrode wiring pattern and comprising a plurality of block electrodes spaced mutually,

wherein the common electrode pattern is also used as a touch electrode pattern, and wherein each of the touch electrode wirings is connected correspondingly to one of the block electrodes in the common electrode pattern.

In an example, the touch electrode wiring pattern is located outside each pixel opening region of the array substrate.

In an example, the common electrode pattern has a gap in a region corresponding vertically to the touch electrode wiring pattern.

In an example, the block electrodes in the common electrode pattern have the gap in a region corresponding vertically to the touch electrode wirings in the touch electrode wiring pattern.

In an example, the touch electrode wiring pattern is located outside a region corresponding vertically to a data line pattern on the array substrate.

In an example, the array substrate further comprises a shielding line pattern formed in the same layer as the touch electrode wiring pattern on the array substrate, the shielding line pattern being formed in the region corresponding to the data line pattern and configured to shield an electrical field generated by the data line pattern.

In an example, the touch electrode wiring pattern is formed in a region corresponding to a black matrix of a color filter substrate.

In an example, the common electrode pattern is made from indium tin oxide and the touch electrode wiring pattern is made from the same material as a gate line of the array substrate.

In an example, the touch electrode wiring pattern is formed between a layer arrangement in which the common electrode pattern is located and a layer arrangement in which the data line pattern on the array substrate is located.

In an example, the array substrate comprises an insulation arrangement formed between the layer arrangement in which the common electrode pattern is located and the layer arrangement in which the data line pattern is located, the touch electrode wiring pattern being insulated from the common electrode pattern and the data line pattern by the insulation arrangement.

In accordance with another aspect of the present invention, it also provides a method for producing an array substrate comprising:

forming a touch electrode wiring pattern on a substrate, the touch electrode wiring pattern comprising a plurality of touch electrode wirings;

forming a common electrode pattern on the substrate formed with the touch electrode wiring pattern, the common electrode pattern being insulated from the touch electrode wiring pattern and comprising a plurality of block electrodes spaced mutually,

wherein the common electrode pattern is also used as a touch electrode pattern, and wherein each of the touch electrode wirings is connected correspondingly to one of the block electrodes in the common electrode pattern.

In an example, the step of forming a common electrode pattern on the substrate comprises:

depositing a common electrode layer and etching the common electrode layer to form the common electrode pattern,

wherein the step of etching the common electrode layer to form the common electrode pattern comprises etching off the common electrode layer located above and corresponding vertically to the touch electrode wiring pattern.

In an example, the step of forming a touch electrode wiring pattern on a substrate comprises:

forming the touch electrode wiring pattern after the data line pattern is formed on the substrate and before the common electrode pattern is formed on the substrate.

In an example, the method further comprises:

forming a shielding line pattern in a region corresponding to the data line pattern in the same layer as the touch electrode wiring pattern when the touch electrode wiring pattern is formed and located outside the region corresponding vertically to the data line pattern on the array substrate.

In an example, the method further comprises:

forming an insulation arrangement between a layer arrangement in which the common electrode pattern is located and a layer arrangement in which the data line pattern is located, the touch electrode wiring pattern being insulated from the common electrode pattern and the data line pattern by the insulation arrangement,

wherein the touch electrode wiring pattern is formed between the layer arrangement in which the common electrode pattern is located and the layer arrangement in which the data line pattern on the array substrate is located.

In accordance with another yet aspect of the present invention, it further provides a display apparatus comprising the above array substrate.

In the embodiments of the present invention, the common electrode pattern includes a plurality of block electrodes spaced mutually and is also used as the touch electrode pattern. The touch electrode wiring pattern includes a plurality of touch electrode wirings, each of which is connected correspondingly to one block electrode. It can reduce the thickness and the production difficulty of the touch display apparatus in comparison with the manner of forming a layer of touch electrode separately in the prior art.

### BRIEF DESCRIPTION OF THE DRAWINGS

FIG. 1 is a schematic cross sectional view of an array substrate according to a first embodiment of the present invention;

FIG. 2 is a schematic view showing a position relation between a touch electrode wiring pattern and a common electrode pattern in the array substrate shown in FIG. 1;

FIG. 3 is a schematic cross sectional view of another array substrate according to a second embodiment of the present invention;

FIG. 4 is a schematic view showing a position relation between a touch electrode wiring pattern and a common electrode pattern in the array substrate shown in FIG. 3;

FIG. 5 is a schematic cross sectional view of another array substrate according to a third embodiment of the present invention; and

FIG. 6 is a flow chart showing a method for producing an array substrate according a fourth embodiment of the present invention.

### DETAILED DESCRIPTION OF PREFERRED EMBODIMENTS OF THE INVENTION

Exemplary embodiments of the present disclosure will be described clearly below in detail with reference to drawings. The objects, solutions and advantages of the embodiments of the present invention will become more apparent after reading the following description. Apparently, the following embodiments are part of the embodiments of the present invention, instead of all of the embodiments. On the basis of the following embodiments, the skilled person in the art can obtain other embodiments without taking inventive labors. All of the other embodiments fall within the scope of the present invention.

### First Embodiment

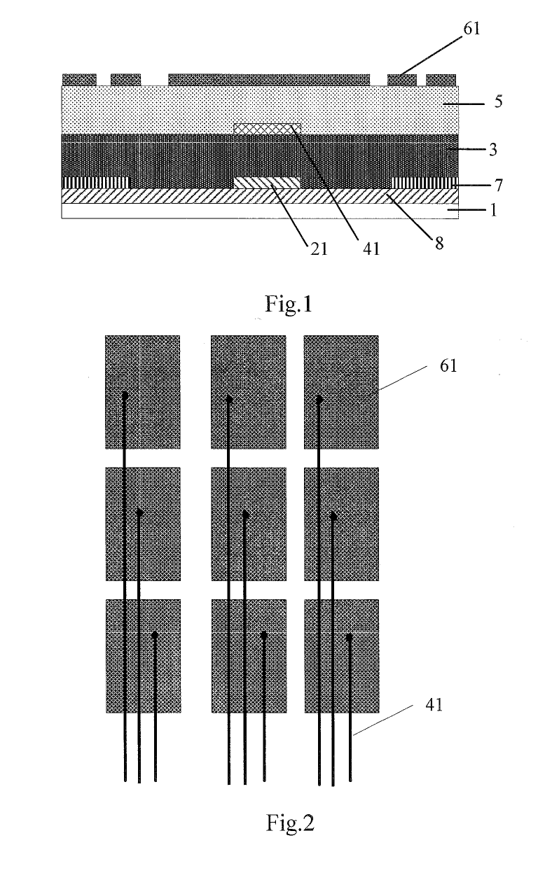

The first embodiment of the present invention provides an array substrate, as illustrated in FIGS. 1-2. The array substrate includes: a substrate 1; a data line pattern formed on the substrate and composed of the data lines 21 shown in FIG. 1; an insulation layer 3 formed on the data line pattern; a touch electrode wiring pattern formed on the insulation layer 3 and composed of a plurality of touch electrode wirings 41 shown in FIGS. 1-2; a passivation layer 5 on the insulation layer 3 and the touch electrode wiring pattern; a common electrode pattern formed on the passivation layer 5 and composed of a plurality of block electrodes 61 spaced mutually. Each of the touch electrode wirings 41 is connected correspondingly to one of the block electrodes 61 in the common electrode pattern.

In an example of the present invention, the common electrode pattern is also used as a touch electrode pattern. In this way, it is possible to avoid separately forming a layer of common electrode pattern. Thus, the thickness of the corresponding touch display apparatus can be reduced and a step of forming the touch electrode pattern separately can be omitted. Thus, the difficulty of production can be reduced.

In FIG. 1, a pixel electrode pattern 7 is also shown. The pixel electrode pattern 7 is formed in the same layer as the data line pattern. In practice, the above array substrate should also include other arrangements configured to form transistors such as a gate electrode pattern, a source and drain electrode pattern. The arrangements are indicated in common by reference numeral 8 in the figure. The details thereof will be omitted herein. It should be understood that the passivation layer herein is also insulating per se and the passivation layer and the above insulation layer form an insulation arrangement for insulating the common electrode pattern from the data line pattern, the gate line pattern and the touch electrode wiring pattern together.

In a specific example, the size of the block electrodes 61 may be identical to that of a pixel region herein. One touch electrode is formed in each pixel region. Or the size of the block electrodes 61 may also be identical to the size of a plurality of pixel regions. The block common electrode 61 may be formed in a specified region, or may be formed in an entire display region.

In a specific example, the touch electrode wiring pattern may be formed outside the pixel opening region herein. In particular, it may be formed in a region corresponding to a black matrix of a color filter substrate. It this way, the aperture opening ratio of the pixel may advantageously be prevented from being degraded.

The common electrode pattern may be made from Indium tin oxide herein. The touch electrode wiring pattern may be made from a metal, in particular, the touch electrode wiring pattern may be made from the same material as the gate line of the array substrate herein.

### Second Embodiment

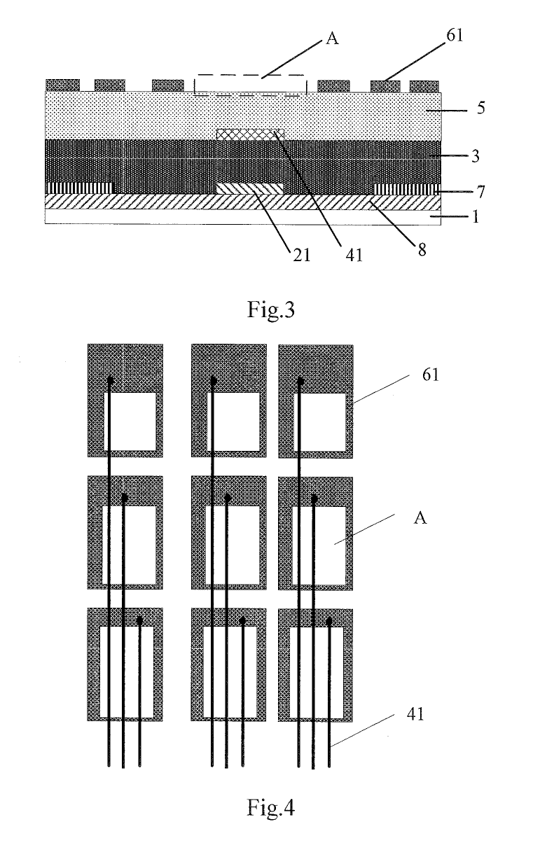

The second embodiment of the present invention provides another array substrate, as illustrated in FIGS. 3-4. The second embodiment is distinguished from the first embodiment in that the common electrode pattern has a gap in a region corresponding vertically to the touch electrode wiring 41 of the touch electrode wiring pattern (as illustrated in FIGS. 3-4, a gap A is formed just above the direct top touch electrode wiring 41), that is, no common electrode layers are formed in at least part of the regions directly above the touch electrode wirings 41. In this way, the vertically overlapped capacitance formed by the touch electrode wiring pattern and the common electrode pattern can be reduced efficiently so as to avoid time delay of the touch electrode pattern caused by the overlapped capacitance.

### Third Embodiment

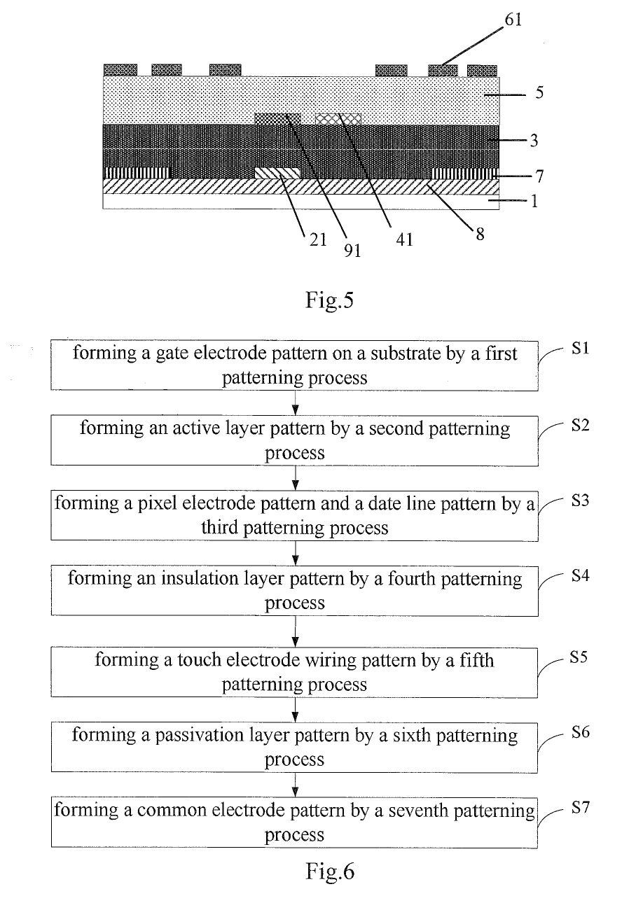

The third embodiment of the present invention provides another array substrate, as illustrated in FIG. 5. The third embodiment is distinguished from the second embodiment in that the touch electrode wiring 41 in the touch electrode wiring pattern is formed outside a region corresponding vertically to the date line 21 in the data line pattern on the array substrate. Similarly, by forming the touch electrode wiring pattern outside the region corresponding to the data line pattern on the array substrate, the vertically overlapped capacitance formed by the touch electrode wiring pattern and the data line pattern can also be avoided to improve the response speed of the touch electrode pattern.

In a further example, as illustrated in FIG. 5, the array substrate further includes a shielding line pattern formed in the same layer as the touch electrode wiring pattern on the array substrate. The shielding line pattern is composed of shielding lines 91 as shown in the figure. The shielding lines 91 in the shielding line pattern are formed in the region corresponding to the data line 21 in the data line pattern (as illustrated in FIG. 5, the shielding lines 91 are formed just above the data line 21) and configured to shield an electrical field generated by the data line 21.

By forming the shielding line pattern to shield the electrical field generated by the data line 21, the capacitance between the touch electrode pattern and the data line pattern can further be reduced to improve the response speed of the touch electrode pattern. In a specific example, the shielding lines in the shielding line pattern have orientations identical to those of the touch electrode wirings and the data lines herein. It should be noted that the region in which the shielding lines 91 are formed and which corresponds to the data line 21 in the data line pattern is not intended to limit the shielding lines 91 to be located just above the data lines 21, for example, the shielding lines 91 may also be formed above the data lines 21 and displaced towards the side of the data line 21 close to the touch electrode wiring 41. In this way, it can also achieve good shielding effects. The corresponding solutions should also be considered to fall within the protect scope of the present invention.

It should be noted that the touch electrode wiring pattern being formed in the region corresponding to the data line pattern on the array substrate separately without being formed outside the region corresponding to the common electrode pattern or the shielding line pattern being formed separately to shield the electrical field generated by the data line pattern, may also reduce the capacitance between the touch electrode pattern and the data line pattern to improve the response speed of the touch electrode wirings.

It should be noted that the above embodiments show the case in that the touch electrode wiring pattern is formed between the layer arrangement in which the common electrode pattern is located and the layer arrangement in which the data line pattern on the array substrate is located, however, in practice, the reduction of the thickness of the touch display apparatus may also be achieved by forming the touch electrode wiring pattern on other positions, and thus the difficulty in production will be reduced. The corresponding technical solutions should also fall within the protect scope of the present invention.

### Fourth Embodiment

An embodiment of the present invention provides a method for producing an array substrate. The method may be used to produce the array substrate as described in any one of the above embodiments. As illustrated in FIG. 6, the method includes:

Step S1 of forming a gate electrode pattern on a substrate by a first patterning process;

Step S2 of forming an active layer pattern by a second patterning process;

Step S3 of forming a pixel electrode pattern and a date line pattern by a third patterning process;

Step S4 of forming an insulation layer pattern by a fourth patterning process;

Step S5 of forming a touch electrode wiring pattern by a fifth patterning process;

Step S6 of forming a passivation layer pattern by a sixth patterning process;

Step S7 of forming a common electrode pattern by a seventh patterning process.

The first to seventh patterning processes may be directed to a process in which photo resist is coated on the corresponding layer arrangements after forming the respective layer arrangements, the photo resist is exposed to a light by a mask and developed, and then the corresponding layer arrangements are etched by using the exposed and developed photo resist as a protective layer to form the corresponding pattern. In this way, in particular, in the Step S7, the transparent electrode material (such as Indium tin oxide) may be deposited to form the common electrode layer, and then the common electrode layer is exposed to a light, developed and etched to enable the common electrode layer to become a plurality of block electrodes, which form the common electrode layer pattern.

In an example, in the above step S7, the common electrode in the common electrode layer being located above and corresponding to the touch electrode wiring may also be etched off. In this way, the producing method can be used to form the array substrate described in the second embodiment.

In an example, in the above step S5, the shielding line pattern may be formed in the region corresponding to the data line pattern while being in the same layer and in the same step as that of the touch electrode wiring pattern. In this way, the producing method can be used to form the array substrate described in the third embodiment.

It should be noted that the fourth embodiment shows the array substrate is produced by seven patterning processes, however, in practice, the process for producing the array substrate is not limited to this. As long as it can form the touch electrode wiring pattern and the common electrode pattern on the substrate and the touch electrode wiring pattern includes a plurality of touch electrode wirings, the common electrode pattern includes a plurality of block electrodes spaced mutually and each of the touch electrode wiring is connected correspondingly to one block electrode, the array substrate produced by the corresponding technical solution can solve the technical problem proposed in the present disclosure and the corresponding technical solution should also fall within the protect scope of the present invention.

An embodiment of the present invention provides a display apparatus. The display apparatus may include the array substrate as described in any one of the above embodiments.

The display apparatus may be any products or components having display function, such as an electronic paper, a cell phone, a tablet computer, a TV, a display, a notebook computer, a digital camera frame or a navigator.

Although several exemplary embodiments have been shown and described, the present invention is not limited to those and it would be appreciated by those skilled in the art that various changes or modifications may be made in these embodiments without departing from the principles and spirit of the disclosure. These changes or modifications will fall within the scope of the present invention. The scope of the present invention is defined by the appended claims and their equivalents.

What is claimed is:

1. An array substrate comprising:
a substrate;
a touch electrode wiring pattern formed on the substrate, the touch electrode wiring pattern comprising a plurality of touch electrode wirings;
a common electrode pattern formed on the substrate, the common electrode pattern being insulated from the touch electrode wiring pattern and comprising a plurality of block electrodes spaced mutually,
wherein the common electrode pattern is also used as a touch electrode pattern, and wherein each of the touch electrode wirings is connected correspondingly to one of the block electrodes in the common electrode pattern.

2. The array substrate according to claim 1, wherein the touch electrode wiring pattern is located outside each pixel opening region of the array substrate.

3. The array substrate according to claim 1, wherein the common electrode pattern has a gap in a region corresponding vertically to the touch electrode wiring pattern.

4. The array substrate according to claim 3, wherein the block electrodes in the common electrode pattern has the gap in a region corresponding vertically to the touch electrode wirings in the touch electrode wiring pattern.

5. The array substrate according to claim 1, wherein the touch electrode wiring pattern is located outside a region corresponding vertically to a data line pattern on the array substrate.

6. The array substrate according to claim 5, further comprising a shielding line pattern formed in the same layer as the touch electrode wiring pattern on the array substrate, the shielding line pattern being formed in the region corresponding to the data line pattern and configured to shield an electrical field generated by the data line pattern.

7. The array substrate according to claim 1, wherein the touch electrode wiring pattern is formed in a region corresponding to a black matrix of a color filter substrate.

8. The array substrate according to claim 7, wherein the common electrode pattern is made from indium tin oxide and the touch electrode wiring pattern is made from the same material as a gate line of the array substrate.

9. The array substrate according to claim 2, wherein the touch electrode wiring pattern is formed between a layer arrangement in which the common electrode pattern is located and a layer arrangement in which the data line pattern on the array substrate is located.

10. The array substrate according to claim 9, wherein the array substrate comprises an insulation arrangement formed between the layer arrangement in which the common electrode pattern is located and the layer arrangement in which the data line pattern is located, the touch electrode wiring pattern being insulated from the common electrode pattern and the data line pattern by the insulation arrangement.

11. The array substrate according to claim 3, wherein the touch electrode wiring pattern is formed between a layer arrangement in which the common electrode pattern is located and a layer arrangement in which the data line pattern on the array substrate is located.

12. The array substrate according to claim 11, wherein the array substrate comprises an insulation arrangement formed between the layer arrangement in which the common electrode pattern is located and the layer arrangement in which the data line pattern is located, the touch electrode wiring pattern being insulated from the common electrode pattern and the data line pattern by the insulation arrangement.

13. The array substrate according to claim 5, wherein the touch electrode wiring pattern is formed between a layer arrangement in which the common electrode pattern is located and a layer arrangement in which the data line pattern on the array substrate is located.

14. The array substrate according to claim 13, wherein the array substrate comprises an insulation arrangement formed between the layer arrangement in which the common electrode pattern is located and the layer arrangement in which the data line pattern is located, the touch electrode wiring pattern being insulated from the common electrode pattern and the data line pattern by the insulation arrangement.

15. A method for producing an array substrate comprising:
forming a touch electrode wiring pattern on a substrate, the touch electrode wiring pattern comprising a plurality of touch electrode wirings;
forming a common electrode pattern on the substrate formed with the touch electrode wiring pattern, the common electrode pattern being insulated from the touch electrode wiring pattern and comprising a plurality of block electrodes spaced mutually,
wherein the common electrode pattern is also used as a touch electrode pattern, and wherein each of the touch electrode wirings is connected correspondingly to one of the block electrodes in the common electrode pattern.

16. The method according to claim 15, wherein the step of forming a common electrode pattern on the substrate comprises:
depositing a common electrode layer and etching the common electrode layer to form the common electrode pattern,
wherein etching the common electrode layer to form the common electrode pattern comprises etching off the common electrode layer located above and corresponding vertically to the touch electrode wiring pattern.

17. The method according to claim 15, wherein the step of forming a touch electrode wiring pattern on a substrate comprises:
forming the touch electrode wiring pattern after the data line pattern is formed on the substrate and before the common electrode pattern is formed on the substrate.

18. The method according to claim 15, further comprising:
forming a shielding line pattern in a region corresponding to the data line pattern in the same layer as the touch electrode wiring pattern when the touch electrode wiring pattern is formed and located outside the region corresponding vertically to the data line pattern on the array substrate.

19. The method according to claim 15, further comprising:
forming an insulation arrangement between a layer arrangement in which the common electrode pattern is located and a layer arrangement in which the data line pattern is located, the touch electrode wiring pattern being insulated from the common electrode pattern and the data line pattern by the insulation arrangement,
wherein the touch electrode wiring pattern is formed between the layer arrangement in which the common electrode pattern is located and the layer arrangement in which the data line pattern on the array substrate is located.

20. A display apparatus comprising the array substrate according to claim 1.
